(19) United States
(12) Patent Application Publication
(10) Pub. No.: US 2021/0272216 A1
(43) Pub. Date: Sep. 2, 2021

(54) SEVERANCE EVENT MODELING AND MANAGEMENT SYSTEM

(71) Applicant: ePerkz, LLC, Johns Creek, GA (US)

(72) Inventors: Sarah J. RODEHORST, Johns Creek, GA (US); Janice EDWARDS, Atlanta, GA (US)

(73) Assignee: ePerkz, LLC, Johns Creek, GA (US)

(21) Appl. No.: 17/182,772

(22) Filed: Feb. 23, 2021

Related U.S. Application Data
(60) Provisional application No. 62/982,743, filed on Feb. 27, 2020.

(51) Int. Cl. G06Q 40/00; G06Q 30/00; G06Q 10/10

(52) U.S. Cl. CPC G06Q 40/125; G06Q 50/18; G06Q 10/1053; G06Q 30/018

(57) ABSTRACT

Disclosed herein are severance event management systems and methods. The severance event management system is an expert system that can predict costs, compliance issues, execution time, and other aspects of severance events. The severance event management system also includes a collaborative platform for managing severance events and data collected during the RIF process. To streamline collaboration on the platform, the roles and permissions of each user are managed by the severance event management system according to the type of user to ensure each user is aware of the portions of the RIF process they are required to complete and maintain the privacy of the individuals impacted by the RIF event. The platform also generates a comprehensive litigation report that provides a full record of all documents, messages, events, and data related to a particular severance project.

### CROSS REFERENCE TO RELATED APPLICATIONS

This application claims the benefit of U.S. Provisional Application Ser. No. 62/982,743 filed Feb. 27, 2020, the entire contents of which is hereby incorporated by reference.

### FIELD OF DISCLOSURE

The present disclosure relates generally to expert systems for aggregating and analyzing employment data and managing employment events. More specifically, the disclosure relates to predicting severance amounts and assembling a record of compliance events during a reduction in force (RIF) event to lower the risk of an adverse outcome in litigation.

### BACKGROUND

RIF events are part of any successful organization. Even in the best economic conditions, organizations need to adapt to meet new market opportunities and use resources more efficiently. For large organizations, RIF events can impact potentially hundreds, or thousands of employees located at sites spread out all over the world. Therefore, successful RIF events often require collecting and managing data received from multiple users with different responsibilities and skill sets. Despite the complexity and scale of RIF events, most RIF systems track and manage severance events using a combination of spreadsheets and messaging technologies such as email. RIF systems also lack the ability to model future severance events by providing decision makers with information about the potential costs, compliance issues, and execution time for severance events. Without specialized tools, managing severance events is a tedious process that takes months to complete. The limitations of RIF systems also prevent employers from making informed decisions about future severance events and compiling data that can predict the business impacts of RIF decisions.

Severance events are highly regulated by a combination of state and federal laws. Therefore, modeling and tracking severance events requires generating and monitoring a large volume of data points. Compliance with the relevant regulations is difficult to track and prove using current RIF systems because of the in-ability of these systems to centrally track severance events to completion and assemble a complete record of all data required to demonstrate compliance. Current RIF systems also lack the data and expertise to model compliance issues for future events. Manual RIF systems, therefore, increase the risk of non-compliance and litigation and prevent companies from compiling data that can be used to model future events and predict compliance risks. Additionally, if an organization is sued, the time required to aggregate compliance documentation from a variety of disparate locations and files significantly increases the costs of litigation. Completing severance events also often requires coordinated action among many members of an organization. Manual RIF systems lack version control, therefore, every team member working on an event often has their own unique tracking system and idea of where the process is at any given point in time. With no way to ensure every team member is working on the same information, manual systems result in a lot of duplicate work and increase the time and cost required to complete and RIF event. Manual RIF systems also lack the ability to manage the roles and permissions of different types of users. Therefore, it is difficult for team members to understand the tasks they are required to complete in order to execute the RIF event. The lack of clearly defined roles for each team member in manual RIF systems increases the amount of time and resources required to complete RIF events.

### SUMMARY

In one aspect disclosed herein are methods for managing severance events comprising: generating a severance event for a reduction in force event; receiving one or more pieces of employee data for an employee impacted by the reduction in force event from a network-based storage device having a collection of employee data stored thereon; calculating an amount of severance compensation the employee will receive during the severance event; generating an assignment including a review action item for reviewing a piece of compliance data for the severance event, wherein the piece of compliance data determines if the severance event complies with an employment regulation; receiving a confirmation that the assignment has been completed; and upon receiving the confirmation, generating a litigation report for the severance event including the one or more pieces of employee data, the amount of severance compensation, the piece of compliance data, and the confirmation.

In one aspect, the methods further comprise generating a severance agreement using the one or more pieces of employee data. In one aspect, the piece of compliance data includes a Worker Adjustment and Retraining Notification Act of 1988 (WARN) report. In one aspect, the piece of compliance data includes an adverse impact report.

In one aspect, the methods further comprise storing the severance event in a standard formant on a network-based storage device having a collection of severance events stored thereon; and providing remote access to the severance event to a plurality of users over a network so any one of the users can update at least one piece of data included in the severance event in real time through a user interface. In one aspect, the methods further comprise generating a second review action item included in the assignment, wherein the second review action item comprises reviewing a second piece of compliance data for the severance event; receiving a request to modify the severance event based on the second piece of compliance data modifying the one or more pieces of employee data based on the request; updating the second piece of compliance data to incorporate the modified one or more pieces of employee data; generating an updated assignment including the updated second piece of compliance data; and receiving a second confirmation that the updated assignment has been completed.

In one aspect, the methods further comprise distributing the amount of severance compensation to the employee. In one aspect, the methods further comprise modeling a severance event by including the employee in an impacted group of employees based on at least one criterion. In one aspect, the at least one criterion includes at least one of a role, a manager, and a location. In one aspect, the amount of severance compensation is calculated based on a severance calculation algorithm. In one aspect, the severance calculation algorithm includes at least one configurable parameter, the at least one configurable parameter including at least one of a role, a service time, a management level, a grade, a location, and a salary.

In one aspect, the methods further comprise generating at least one of a financial report, a severance action report, and a compliance report for the severance event. In one aspect, the methods further comprise analyzing at least one piece of data included in at least one of the litigation report, the financial report, the severance action report, and the compliance report to generate a prediction for a new severance event.

In one aspect, disclosed herein are systems for managing severance events comprising: a memory; and a processor in communication with the memory and configured to: generate a severance event for a reduction in force event; receive one or more pieces of employee data for an employee impacted by the reduction in force event from a network-based storage device having a collection of employee data stored thereon; calculate an amount of severance compensation the employee will receive during the severance event; generate an assignment including a review action item for reviewing a piece of compliance data for the severance event, wherein the piece of compliance data determines if the severance event complies with an employment regulation; receive a confirmation that the assignment has been completed; and generate a litigation report for the severance event including the one or more pieces of employee data, the amount of severance compensation, the piece of compliance data, and the confirmation.

In one aspect, the processor is further configured to generate a severance agreement using the one or more pieces of employee data. In one aspect, the piece of compliance data includes a Worker Adjustment and Retraining Notification Act of 1988 (WARN) report. In one aspect, the piece of compliance data includes an adverse impact report. In one aspect, the processor is further configured to: store the severance event in a standard formant on a network-based storage device having a collection of severance events stored thereon; and provide remote access to the severance event to a plurality of users over a network so any one of the users can update at least one piece of data included in the severance event in real time through a user interface.

In one aspect, the processor is further configured to: generate a second review action item included in the assignment, wherein the second review action item comprises reviewing a second piece of compliance data for the severance event; receive a request to modify the severance event based on the second piece of compliance data; modify the one or more pieces of employee data based on the request; update the second piece of compliance data to incorporate the modified one or more pieces of employee data; generate an updated assignment including the updated second piece of compliance data; and receive a second confirmation that the updated assignment has been completed.

In one aspect, disclosed herein are devices comprising: a display; an input device; and a processor in communication with the display and the input device and configured to: generate a severance event for a reduction in force event; receive one or more pieces of employee data for an employee impacted by the reduction in force event from a network-based storage device having a collection of employee data stored thereon; calculate an amount of severance compensation the employee will receive during the severance event; generate an assignment including a review action item for reviewing a piece of compliance data for the severance event, wherein the piece of compliance data determines if the severance event complies with an employment regulation; receive a confirmation that the assignment has been completed; and generate a litigation report for the severance event including the one or more pieces of employee data, the amount of severance compensation, the piece of compliance data, and the confirmation.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts an exemplary system managing severance events, according to embodiments of the disclosure.

FIG. 2 illustrates more details of a severance management system, according to embodiments of the disclosure.

FIG. 3 illustrates more details of a modeling module, severance calculator, and document generator, according to embodiments of the disclosure.

FIG. 4A illustrates an exemplary agreement exhibit, according to embodiments of the disclosure.

FIGS. 4B-D illustrate components of an exemplary modeling UI, according to embodiments of the disclosure.

FIG. 5. illustrates an exemplary UI displaying severance amounts calculated by a severance calculator, according to embodiments of the disclosure.

FIG. 6 illustrates more details of an exemplary assignment generator and review module, according to embodiments of the present disclosure.

FIGS. 7A-B illustrates a UI displaying exemplary assignments generated by the assignment generator, according to embodiments of the disclosure.

FIG. 8 illustrates more details of an exemplary report generator and analytics engine, according to embodiments of the disclosure.

FIGS. 9A-B illustrate a UI displaying exemplary compliance reports generated by the report generator, according to embodiments of the disclosure.

FIG. 10 is a flow chart illustrating an exemplary method for managing severance events, according to embodiments of the disclosure.

FIG. 11 is a block diagram illustrating an exemplary client device, according to embodiments of the disclosure.

### DETAILED DESCRIPTION

Disclosed herein are systems and methods for modeling and managing RIF events including, for example, severance events created in response to employee terminations, furloughs, and the like. The disclosure includes an expert system that can predict costs, compliance issues, execution time, and other aspects of severance events. By modeling future severance events, the disclosed system provides decision makers with detailed information that they can use to determine to pursue a RIF event and, if so, assemble lists of considered and impact employees to do not result in a high risk of litigation. The disclosure also includes a collaborative platform for managing severance events and data collected during the RIF process. Workflows built into the platform leverage domain specific logic to ensure the severance event complies with relevant state and federal regulations. The platform calculates and continuously updates severance amounts based on employment data, policies of the organization, and requirements of local regulators. Data collected by the platform is also used to generate severance agreements that are then assigned to users to review and sign. By integrating communications and data collected from impacted employees and specialists in human resources, legal, investigations, immigration, compensation, employee relations, people operations, and other business operations in a centralized location, the platform ensures data is shared across multiple users in an organization and all users involved in an event can work on the same version of the event file. The roles and permissions of each user are managed by the severance event management system according to the type of user to ensure each user is aware of the portions of the RIF process they are required to complete and maintain the privacy of the individuals impacted by the RIF event. The platform also generates a comprehensive litigation report that provides a full record of all documents, messages, events, and data related to a particular severance project.

The platform establishes a version controlled collaborative environment for users working on a RIF project to efficiently track and manage severance events. By aggregating a complete history of everything that occurred during a severance event in a standard format, the platform can be used to lower the risk of litigation and reduce legal fees if an organization is sued. The RIF system may extract user preferences from the historical data of previous RIF events for a particular customer and or user. The user preferences may be imported into a RIF event that is pre-configured according to the user's specific preferences to reduce the manual setup time required to initiate a new RIF event. The platform also improves the speed and efficiency of RIF systems by automating aspects of the severance process including, for example, severance amount calculation, document generation, compliance review, and the like. The platform also enables faster modeling of severance events by exposing employment data in a searchable user interface to allow rapid assembly and iteration of anonymized lists of employees considered for a RIF event and employees impacted by a RIF event. Financial, employment, processing efficiency, compliance, and other data collected by the platform may be included in reports and analyzed to draw insights that can be used to improve the performance of the platform over time.

The severance event management system may be customized for particular users and or project types. For example, the severance event management system may be customized for a particular company so that the workflows, roles and permissions, event timelines, review process, event modification process, and other severance event parameters used for each of the company's severance events are auto-configured according to the company's internal processes, personnel, and organizational structure. For example, the order and tasks included in each stage of the severance event workflow (i.e., pre-assessment review, population validation, legal review, pending notification, notified, delivered, etc.) may be predetermined based on company policy and or workflows previously used by the company to complete severance events. The employees assigned to complete and review each task may be automatically set up based on a company organization chart and or the roles and permissions used to complete previous severance events. The severance event management system may also ensure the agreements generated during each of the company's severance events have the same style, content, and layout.

The severance event management system may also configure severance events according to the type severance event or project (i.e., a group of related severance events). For example, the workflows, roles and permissions, event timelines, review and modification processes, and other severance event parameters may be auto-configured so that these preferences are the same for all severance events have a particular type and or all severance events included in particular project. To auto-configure severance events based on a particular event type, users may select an event type (e.g., furlough or termination) for a particular severance event. The severance event management system may then auto-configure the severance event parameters based on a user defined set of parameters for severance events and or the parameters of severance events having the same event type that were previously completed by the user. Users may also designate severance events as include in a particular project. The severance event management system may then auto-configure the parameters for all severance events included in the project so that all of the events included in the project are set up the same way.

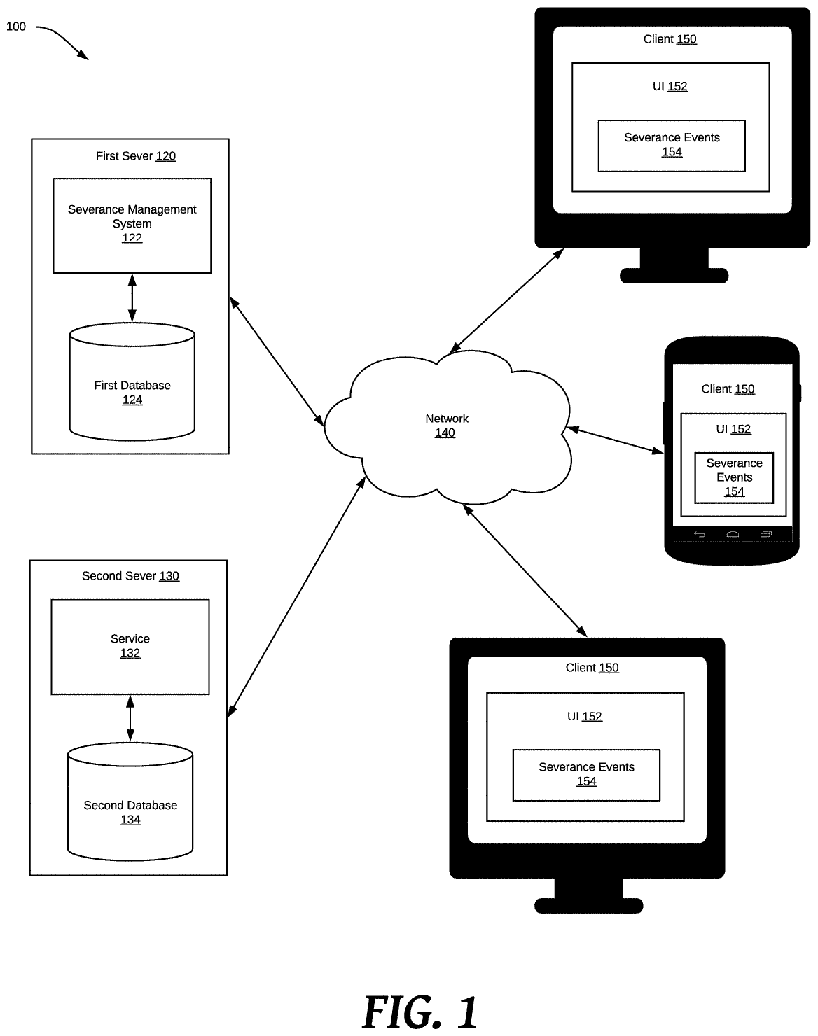

FIG. 1 shows an example of a system 100 configured to implement the process for managing severance events according to an embodiment of the present disclosure. System 100 may include a first server 120, second server 130, and/or one or more client devices 150. First server 120, second server 130, and/or client devices 150 may be configured to communicate with one another through network 140. For example, communication between the elements may be facilitated by one or more application programming interfaces (APIs). APIs of system 100 may be proprietary and/or may be examples available to those of ordinary skill in the art such as Amazon® Web Services (AWS) APIs or the like. Network 140 may be the Internet and/or other public or private networks or combinations thereof.

First server 120 may be configured to implement a severance management system 122, which, in one embodiment, may be used to receive employment data via network 140 from one or more databases 124, 134, the second server 130 and/or client device 150. For example, first server 120 may execute the process for calculating severance amounts and generating severance documents and events according to the disclosed principles using employment data stored in database 124, database 134, and/or received from second server 130 and/or client device 150. The severance management system 122 or second service 132 may implement an information service, which may maintain data concerning user severance events. The information service may be any network 140 accessible service that maintains severance events.

Client device 150 may be any device configured to present user interfaces 152 and receive inputs thereto. For example, client device 150 may be a smartphone, personal computer, tablet, laptop computer, or other device. A client device 150 may display a user interface 152 generated by the severance management system 122. The user interface 152 may include one or more severance events 154. Different versions of the user interface 152 may be displayed to different users of the severance management system 122. For example, a user interface 152 displayed to an employee may include different severance events 154 than a user interface 152 displayed to a legal or HR professional.

First server 120, second server 130, first database 124, and second database 134 are each depicted as single devices for ease of illustration, but those of ordinary skill in the art will appreciate that first server 120, second server 130, first database 124, and/or second database 134 may be embodied in different forms for different implementations. For example, any or each of first server 120 and second server 130 may include a plurality of servers or one or more of the first database 124 and second database 134. Additionally, user interfaces 152 generated by the severance management system 122 may be simultaneously displayed on greater or fewer than three client devices 150 at any given time. Alternatively, the operations performed by any or each of first server 120 and second server 130 may be performed on fewer (e.g., one or two) servers. In another example, a plurality of client devices 150 may communicate with first server 120 and/or second server 130. A single user may have multiple client devices 150, and/or there may be multiple users each having their own client device(s) 150.

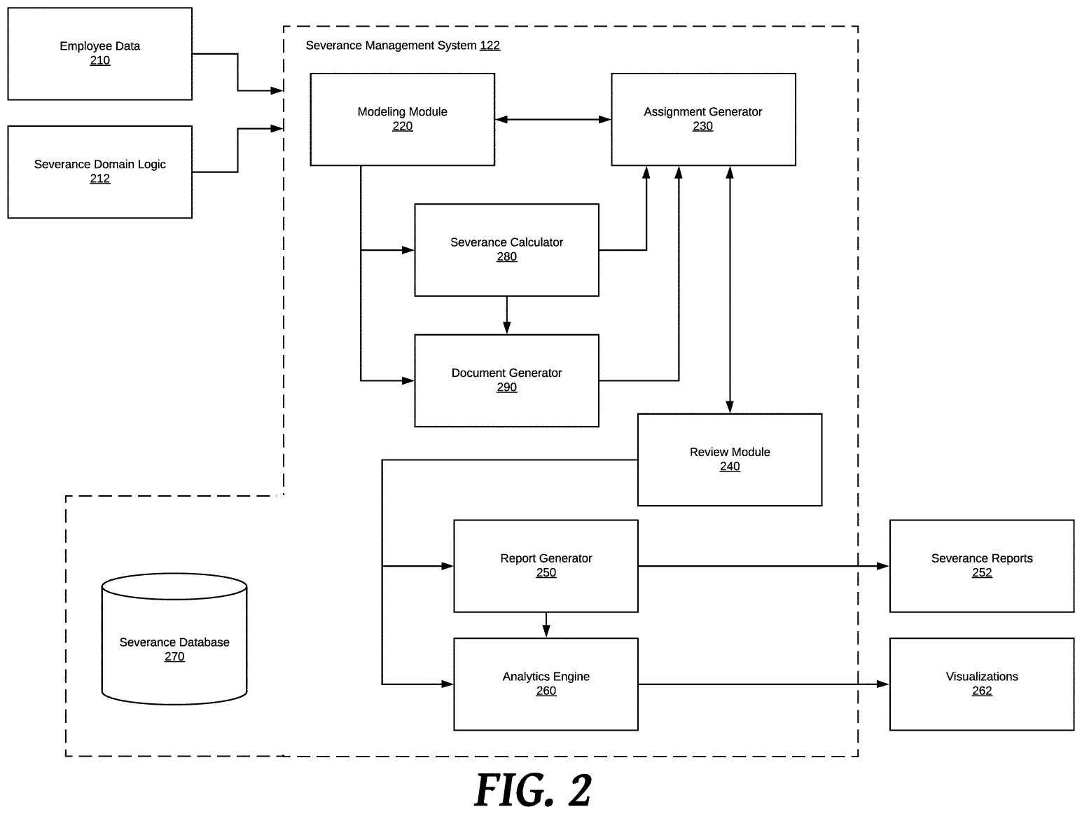

FIG. 2 illustrates one embodiment of a severance management system 122. The severance management system 122 may receive employee data 210 from a remote network-based database or other storage device storing an organization's records. For example, the severance management system 122 may integrate with an organization's Workday® platform or other records management system to receive a daily file of employee data 210. Exemplary data fields included in employee data 210 are shown in the table below:

| | | Field | | |
|---|---|---|---|---|
| Field | | Type/ | Field | |
| # | Field Name | Format | Length | Sample data |
| 1 | Last Name | String | 40 | Doe |
| 2 | First Name | String | 40 | John |
| 3 | Middle Initial | String | 1 | S |
| 4 | Employee | String | 40 | 012345 |
| | Number | | | |
| 5 | Continuous | Date | 10 | 12/31/2010 |
| | Service Date | | | |
| 6 | Job Title | String | 40 | Software Engineer |
| 7 | Grade | String | 40 | T2 |
| 8 | Management | String | 40 | Individual |
| | Level | | | Contributor |
| 9 | Salary | Number | 20 | 96000.00 |
| 10 | Annual Bonus | Number | 5 | 0.15 |
| | % | | | |
| 11 | Bonus Plan | String | 40 | Corporate-AIP |
| 12 | Disabled | String | 40 | Y/N |
| 13 | Ethnicity | String | 40 | Asian (United |
| | | | | States of America) |
| 14 | DOB | String | 10 | 12/31/1990 |
| 15 | Gender | String | 40 | Male |
| 16 | Employment | String | 40 | A |
| | Status | | | |
| 17 | Work Address | String | 40 | 5995 Windward |
| | 1 | | | Pkwy |
| 18 | Work City | String | 40 | Alpharetta |
| 19 | Work State | String | 40 | GA |
| 20 | Manager ID | String | 40 | 031625 |
| 21 | Country | String | 40 | |
| 22 | Visa Type | String | 40 | |
| N | ... | ... | ... | ... |

The employee data 210 may depend on the type of severance event. Accordingly, the employee data 210 may different for severance events created in response to terminations, furloughs, transfers, reassignment, and the like. For example, the employee data 210 for a severance event created in response to a furlough may include work hours, current salary, reduction in work schedule and pay (e.g., a percent reduction in the employees current hours and or salary), proposed new hours, proposed new salary, modifications to the employees role and or job duties the employee is responsible for, and the like. The severance management system may automatically manage the employee data 210 for each type of severance event so that all of the employee data 210 and other data required for the particular type of severance event is extracted from an integrated application and or records managements system.

The severance management system may also receive severance domain logic 212. Severance domain logic 212 may include data, rules, and other computer logic required to implement a process for managing severance events that complies with relevant regulations. For example, severance domain logic 212 may include logic for calculating severance amounts, logic for generating severance agreements, logic for ensuring severance processes comply with applicable laws (e.g., state, federal, and/or local: immigration statues, employment statues, and/or anti-discrimination statues), and the like. Severance domain logic 212 may also include data that defines the parameters for a particular RIF event. Exemplary parameters for the RIF event may include the notification date for each employee impacted by the RIF event (i.e., the date each employee was notified of their change in status), the termination date for each employee impacted by the RIF event, the RIF event type (e.g., termination, reassignment, transition, furlough, etc.), the user assigned to manage the RIF event, and the like.

Severance domain logic 212 may also include organizational data for a particular company and or user of the severance management system 122. Organizational data may include the different types of users required to complete tasks during the RIF process and the tasks assigned to each user. For example, the organizational data may define different user types for employee relations users, investigations users, compensation and immigration users, finance users, legal users, people solution business partner (PSBP) users, human resources business partner (HRBP) users and the like. Each type of user may have specific tasks described in the organizational data that they are required to complete. The organizational data may also include an approval hierarchy of different users that are required to review and or approve tasks completed within the RIF process. The approval hierarchy, user types, and roles for each user included in the organizational data may be found, for example, in an organization chart, job description, or a RIF workflow. Severance domain logic 212 may be extracted from other sources including, for example, legal statues, existing RIF systems, professional guidelines, domain experts, company policies, company benefit schedules, and the like. Severance domain logic 212 may also be mined and/or learned from databases including employee data, employment data, financial data, and the like.

Employee data 210 and/or severance domain logic 212 may be used by one or more components of the severance management system 122. For example, the modeling module 220 may generate one or more modeling UIs that enable users to search employee data 210 to assemble lists of employees impacted by a severance event. The severance calculator 280 may use severance domain logic 212 to calculate severance amounts using employee data 210 for impacted employees. The document generator 290 may generate severance agreements and other documents for a particular impacted employee using severance domain logic 212. The assignment generator 230 may use severance domain logic 212 to generate assignments for users of the severance management system 122 to complete that provides evidence that the severance event complies with applicable regulations. The assignment generator 230 may generate particular tasks for each user type included in the severance domain logic 212. The assignment generator 230 may also deliver notifications of outstanding tasks to users within the severance management system 122. The review module 240 may use severance domain logic 212 to automate aspects of the review process for severance events, for example, by measuring the adverse impact of severance events and documenting notification dates to ensure compliance with notification statues (e.g., the Worker Adjustment and Retraining Notification Act of 1988 (WARN)).

Severance domain logic 212 may be used by the report generator 250 to generate severance reports 252 using employee data 210 and other data collected by the severance management system 122 (e.g., justifications for severance events, impacted employees, considered employees, severance agreements, messages between users, event history, time required to review and complete assignments and/or action items within assignments, modifications to severance events, compliance data, and the like.) Data collected by the severance management system 122 may be stored in a severance database 270. Severance reports 252 may include visualizations 262 generated by the analytics engine 260 that illustrate employee data and other severance data in a chart, graph, figure, or other format that facilitates interpreting the data. The analytics engine 260 may also process employee data 210 and data from the severance database 270 to generate predictions, recommendations, and other insights that may improve the performance of the severance management system over time and provide additional features for users.

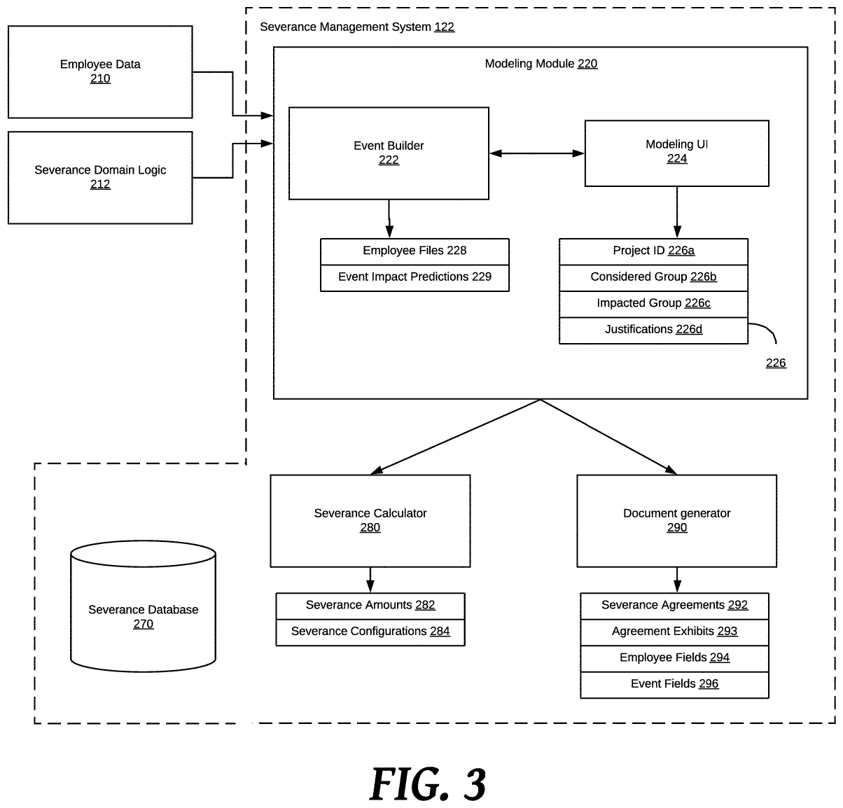

FIG. 3 illustrates an exemplary modeling module 220, severance calculator 280, and document generator 290 of the severance management system 122. The modeling module 220 may include an event builder 222 that receives employee data 210 and severance domain logic 212. The event builder 222 may receive a request from a user to create a RIF event. In response, the event builder 222 may generate a plurality of modeling UIs 224. The modeling UIs 224 may include, for example, a search UI for searching employee data 210, a justification UI for eliciting and capturing a justification for severance events and impacted employees, and a confirmation UI for reviewing and finalizing employee selections. The modeling UIs 224 may capture and/or generate severance event data 226 including a severance project ID 226a, a considered group 226b of employees that were considered for a severance event, an impacted group 226c of employees that were selected for a severance event, and justifications 226d for the severance event and each employee that was selected to be impacted by the severance event.

The event builder 222 may receive the impacted group 226c of employees from the modeling UI 224 and build employee files 228 for each employee included in the impacted group 226c. The employee files 228 may include employee data 210, for example, service time, employee role, employee grade, immigration status, compensation, leave status, workers compensation cases, internal investigation records, and the like. The event builder 222 may also generate event impact predictions 229 that predict the cost, compliance issues, execution time, and other business impacts associated with a severance event. Event impact predictions 229 may be specific to a particular severance event having the particular considered group 226b, impacted group 226c, justifications 226d, and project ID 226a included in the severance event data 226. The event impact predictions 229 may model the business impacts of a particular severance event to allow decision makers to make more informed decisions about RIF events. The event impact predictions 229 may also be used to educate decision makers about the cost, compliance issues, execution time, and other aspects of severance events so they can make RIF decisions that maximize efficiency, minimize costs, and minimize litigation risk. As more severance events are completed on the severance management system 122, data complied during the severance events may be used to improve event impact predictions 229 generated by the event builder 222.

For each employee included in the impacted group, the document generator 290 may generate a severance agreement 292. The document generator 290 may prepare severance agreements 292 by inserting employee fields 294 and/or event fields 296 into a template agreement. For example, the document generator 290 may prepare severance agreements 292 including service level agreements (SLAs), release letters, cover letters, separation letters, Age Discrimination in Employment Act (ADEA) disclaimers, and other documents required to comply with relevant regulations. The document generator 290 may also prepare one or more agreement exhibits 293 or other attachments that are included in one or more of the automatically generated severance agreements 292 and or may be added to manually generated documents.

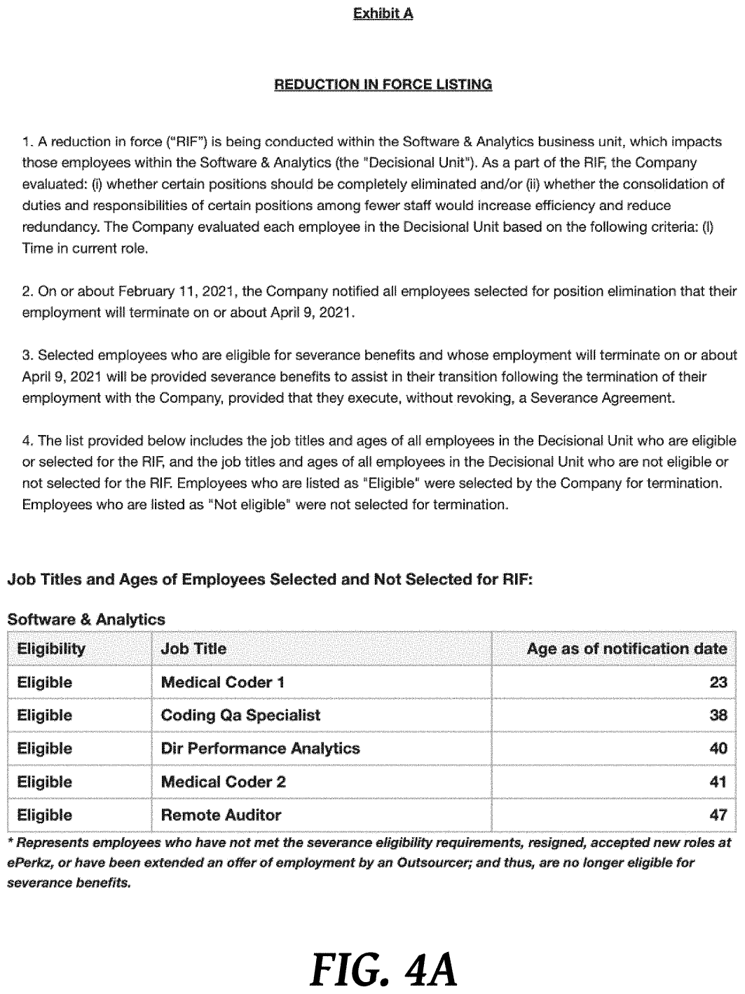

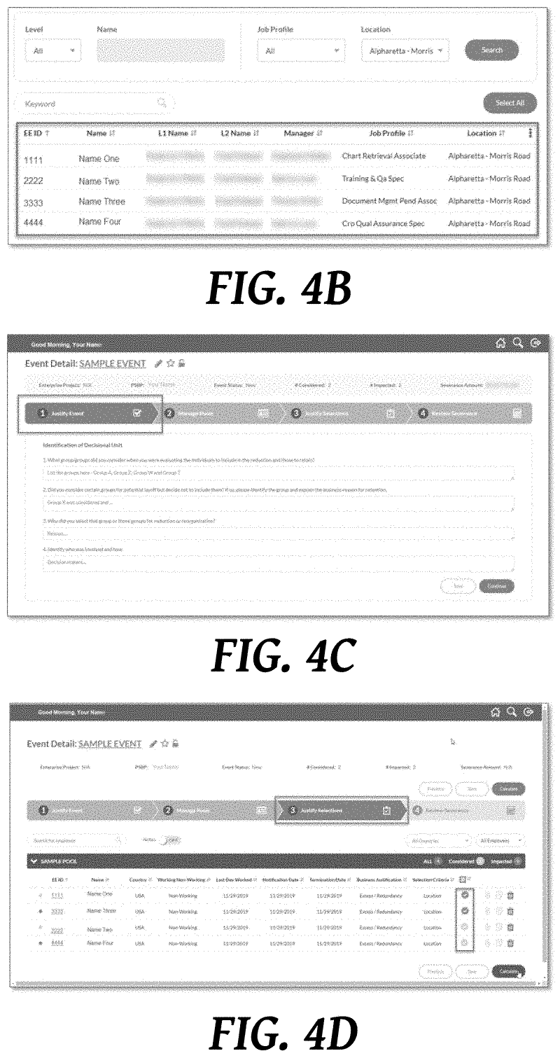

For example, the document generator 290 may generate a reduction in force (RIF) listing shown in FIG. 4A. The RIF listing documents the employee review and approval process by providing a list of all employees that are eligible or were selected for the RIF event. and a list of all employees that are not eligible or were not selected from the RIF event. The severance agreements 292 and agreement exhibits 293 may include automatically generated text, tables, and other graphics. The content of the severance agreements 292 and the agreement exhibits 293 may be generated based on event data 226 (e.g., event fields 296) and or employee data (e.g., employee fields 294) for the severance event. For example, the RIF listing in FIG. 4A includes event data 226 (i.e., the termination date for the impacted employees in sections 2 and 3 and the roles impacted by the RIF event in the “job title” column of the table) and employee data (i.e., the age and severance eligibility for each employee in the table).

The document generator 290 may be configured to generate severance agreements 292 and agreement exhibits 293 in compliance with US laws, Canadian laws, or applicable regulations from any state, province, country, city, region, or other location and/or jurisdiction. The agreement template and employee fields 294 and/or event fields 296 used to generate severance agreements 292 and agreement exhibits 293 may depend on the location where the impacted employee works. The position of the fields within the severance agreements 292 and agreement exhibits 293 and the content of the severance agreements 292 and agreement exhibits may also be specific to the location of the impacted employee's work site.

Employee fields 294 and event fields 296 may be extracted from employee data, captured by the modeling UI 224, extracted from offer letters, employment contracts, or other documents or records, or otherwise captured by the severance management system 122. The agreement templates used to generate the severance agreements 292 and or agreement exhibits 293 may be specific to a particular employer, industry, and/or work site. Exemplary employee fields 294 may include employment dates, employee contact information, employee demographic information, compensation information including salary information, equity compensation, commission compensation, and the like, working status, AIP status, AIP year, employee records, and the like. Exemplary event fields 296 may include a number of review days, benefit information including outplacement months, severance time, and the like, considered group, impacted group, impacted business unit, justifications, terminated roles, impacted work site location, and the like.

The document generator 290 may integrate with an external (e.g., Adobe® E-sign, DocuSign®, and the like) and/or internal (e.g., review UI e-sign function) electronic signature service that allows users to review and sign the severance agreements 292. The document generator 290 may determine the statutory review period of each particular severance agreement 292. The document generator 290 may provide employee data (e.g., email address or other contact information) and the review period for each document (i.e., severance agreement 292 and or agreement exhibit 293) to the electronic signature service and/or review UI. The document generator 290 may use the employee data and review periods to configure the electronic signature service and/or review UI to deliver each document to the correct user and make the document available for review for a period of time that corresponds to the statutory review period. The document generator 290 may also integrate with a document storage service to store severance agreements 292 internally in the severance database 270 or in an external document storage system.

The document generator 290 may be programmed to automatically regenerate severance agreements and other documents in response to one or more modifications made to a severance event. The regenerated documents may be updated to reflect the severance event modifications. For example, the document generator 290 may regenerate severance agreements included an updated termination date and or notification date for the severance event. To regenerate the documents, the document generator 290 may run a Cron job or other time-based scheduler to check the severance event and the previously generated documents at a predetermined time (e.g., every day at 12:00 AM EST). Upon execution of Cron job, document generator 290 may determine the severance agreements 292, agreement exhibits 293, and other documents that need to be updated and update the identified documents to reflect the most recent modifications to the severance event. The document generator 290 may also regenerate severance agreements 292, agreement exhibits 293, and other documents based on one or more events that may occur in the severance event management system. For example, the document generator 290 may regenerate severance agreements 292 and or agreement exhibits 293 when a user makes changes to a severance event, marks a task in the severance event workflow as new, discovers an event exception in an event search, updates one or more parameters of a project including multiple severance events, changes a parameter included in a company profile, and the like. Once the documents are updated, the document generator 290 may replace the documents available on the severance event management system with the updated documents. The document generator 290 may also distribute the updated documents to users of the severance event management system and or impacted employees via email, text message, push notification, other electronic message, and or mailed correspondence.

For each employee included in the impacted group 226c, the severance calculator 280 may calculate severance amounts 282 for the employee. The severance calculator 280 may determine a severance amount using one or more severance calculation algorithms. The severance calculation algorithms may determine severance amounts based on a variety of parameters including, for example, hire date, service time (i.e., total time employed with the employer), role, grade (i.e., an internal employer classification of seniority or rank), salary, other compensation, employment location, management level, minimum severance amount, maximum severance amount, applicable taxes, outplacement benefits, healthcare benefits, and the like. The severance calculation algorithm may also be configured to determine a weighted severance amount that weights severance amounts according to a particular grade and/or management level.

The severance calculator 280 may also determine the number of work days to allow for completing each stage of the severance event (i.e., pre-assessment review, population validation, legal review, pending notification, notified, delivered, signed, and the like). The severance calculator 280 may also determine the due dates for each stage in the severance event by adding the number of remaining work days to the current calendar date. Users can view the work days remaining and due dates for each task assigned to the user's role in their work queue. The severance calculator 280 may determine the number of work days (i.e., the amount of time users have to complete a task) for every stage in a severance event according to a set of event settings that may be stored as one or more severance configurations 284. The event settings specifying the max number of work days allowed for each stage in the severance event may be determined for a particular event type (i.e., reduction in force, furlough, and the like) and or on a per project and or per company basis. For example, administrators and other users having permissions to modify one or more of the severance configurations 284 may determine the max number of work days allowed for each stage in the severance events that are performed by a particular company and or are included in a particular project (i.e., one or more associated reduction in force and or furlough events) The event settings may also define the role of users (e.g., HR, legal, finance, and the like) assigned to a particular stage of a severance event and or the size (i.e., maximum number of employees that may be impacted) of the severance event.

The max number of work days and or earliest notification date may also be determined automatically by the severance calculator 280. The severance calculator 280 may determine the max number of work days based on the stage of the severance event and one or more of the event settings (e.g., size of the severance event) or other severance configurations 284. For example, the severance calculator 280 may determine a higher number of max work days for stages included in larger severance events and a lower number of max work days for stages included in smaller severance events. To resolve conflicting deadlines for tasks included in the same stage of a severance event, the severance calculator 280 may determine the deadline for the stage based on the task and or role having the greatest number of work days. For example, if multiple roles are required to complete different tasks within the same stage of a severance event, the severance calculator 280 may automatically find the role (i.e., legal, HR, finance, etc.) and or task within the stage with the greatest number of work days and calculate the stage due date for each task in the stage based on the role and or task having the greatest number of work days. The severance calculator 280 may also determine the earliest available notification date based on the total number of work days required to complete each stage of the severance event. To determine the earliest available notification date (i.e., earliest date in which impacted employees can be notified of a severance event), the severance calculator 280 may add the total number of work days for each stage together to obtain the total duration of the severance event (i.e., the number of work days required to complete the entire severance event). The severance calculator 280 may then add the number of days included in the total duration (skipping holidays and weekends) to the start date for the pre assessment review stage of the severance event to determine the earliest notification date. The severance management system 122 may then automatically notify impacted employees of the severance event on the earliest notification date.

Users of the severance management system 122 may customize severance calculations by modifying parameters of a severance calculation algorithm and or one or more of the event settings. The parameters and or event settings selected by a user may be stored as one or more severance configurations 284. Severance configurations 284 may be stored in the severance database 270 so that the severance management system 122 may automatically configure the severance calculator 280 based on a particular user role, project, company, severance event type, severance event size, impacted employee data (i.e., employee role, employment location, salary, years of service, immigration status) and or other employment or severance event data.

Data generated by the modeling module 220, severance calculator 280, and document generator 290 may be stored in the severance database 270. Event data 226 stored in the severance database 270 may be used to draw insights about hiring, workforce reduction, severance, and other employment aspects. For example, the roles and grade of employees that were present in the considered group but not eventually selected for the impacted group 226c may be tracked over time to identify roles that are becoming more important to the operations of the organization. Employee files 228, severance amounts 282, severance configurations 284, severance agreements 292, employee fields 294, event fields 296 stored in the severance database 270 may also be analyzed to draw insights and make predictions about how to improve the severance management system 122. For example, the length and composition of severance agreements 292 used by different employers may be tracked over time to synthesize a shorter agreement template that includes a more clear and concise statement of the severance terms between the parties and the applicable laws.

FIGS. 4B-D illustrate exemplary components of the modeling UI 224. FIG. 4B illustrates a search UI for building lists of considered and impacted employees. The search UI allows users to quickly locate relevant data on employees that have one or more relationships, for example, the employees have the same role, share a location, have the same manager, and the like. FIG. 4C illustrates an event justification UI that elicits an event justification from a user. The event justification may explain the business purpose of the severance event and may be required to comply with one or more employment regulations. FIG. 4D illustrates an employee justification UI. The employee justification UI elicits a justification from a user that explains why the particular employee was selected to be part of the considered group and/or selected for the impacted group that will be impacted by the severance event. To ensure the severance process complies with employment regulations, the employee justification UI requires the user to enter justifications for all employees that are included in the impacted group.

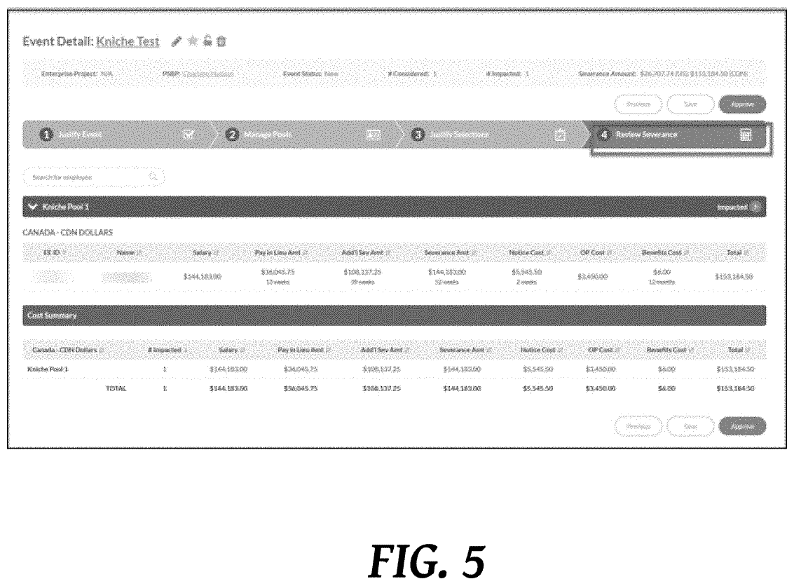

FIG. 5 illustrates severance amounts that were calculated by an exemplary severance calculator 280. As shown in the figure, the severance calculator 280 may determine the severance amount as well as other benefits and costs included in the severance event. For example, the severance calculator 280 may determine the notice cost, the op cost, the benefits costs, and other costs the employer must pay to complete the severance event and/or provide all the benefits received by the employee.

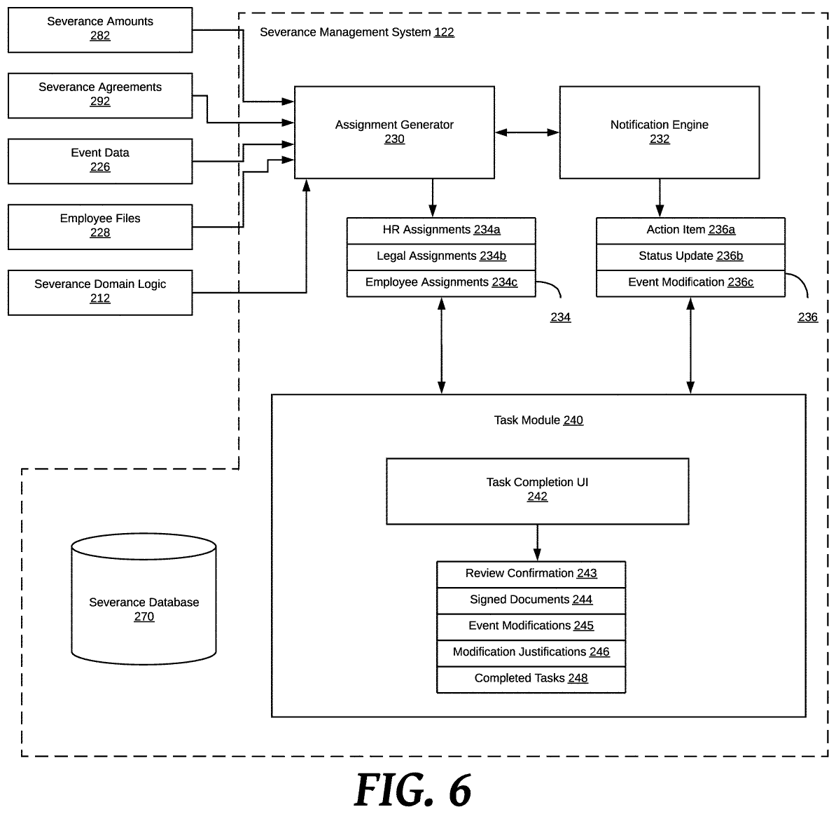

FIG. 6 illustrates more details of the assignment generator 230 and review module 240. The assignment generator 230 may generate severance assignments 234 using severance amounts 282, severance agreements 292, event data 226, employee files 228, and severance domain logic 212. The severance assignments 234 may include one or more action items that must be completed during the severance process. The severance assignments 234 may be generated according to one or more severance event workflows included in the severance domain logic 212. For example, the severance domain logic 212 may define a severance event workflow including multiple stages (e.g., pre-assessment review, population validation, legal review, pending notification, notified, delivered, and signed). Each of the multiple stages in the workflow may include on or more tasks that need to be completed in order to execute the severance event. The severance assignments 234 may include the tasks for each stage in the workflow. The severance assignments 234 may be different for different users of the severance event management system and the severance logic 212 may define the tasks to be performed by each type of user. For example, human resource (HR) assignments 234a may include tasks for HR professionals, such as, modify the impacted group, reassign a particular employee, modify the severance amount, distribute the severance agreement to the employee, and the like. Legal assignments 234b may include tasks for legal professionals, such as, review the assignment agreement, determine if the severance event complies with applicable legal regulations (e.g., WARN and adverse impact regulations), determine if an employee having a specific leave status or other employee relation status can be included in a severance event, and the like. Employee assignments 234c may include tasks for employees impacted by a severance event, for example, indicate that they received notice of the severance event, review and sign a severance agreement, review severance amount, and the like. The severance assignments 234 may also include review tasks to be completed by one or more users. The review tasks confirm the work performed in one or more completed tasks is accurate and the review tasks may be assigned to users based on the approval hierarchy included in the severance domain logic.

The assignment generator 230 may include a notification engine 232 that generates and distributes notifications 236 to users of the severance management system 122. The notifications 236 alert the users when they have received a new assignment or a task within a previously received assignment requires their attention. Notifications 236 may also help users of the severance management system 122 track severance events until completion. The notification engine 232 may be integrated with an email, text message, push notification, instant messenger, or other messaging service to distribute the notifications to a client device. Notifications 236 generated by the notification engine 232 may include action item notifications 236a that may, for example, alert users when they have new tasks to complete, when they have new assignments 234, when other users have taken action on a task the users collaborate on, and the like. The notification engine 232 may also generate status update notifications 236b that may alert users when the status of an assignment 234 and/or action item has changed, for example, an action item and/or assignment 234 has been started, is in progress, and/or has been completed. Event modification notifications 236c may alert users when an action item and/or assignment 234 included in a severance event has been changed. For example, an event modification notification 236c may alert a user when the compensation amount, severance agreement, employee address, or some other aspect of an assignment 234 and/or task for a severance event has been changed.

Assignments 234 may be distributed to a task module 240. The review module 240 may generate a task completion UI 242 that displays assignments 234 and collects data from users completing the assignments 234. The task completion UI 242 may collect data that provides evidence a user has reviewed a severance event. For example, the task completion UI 242 may collect a review confirmation 243 that confirms a user has reviewed and approved the severance event. The task completion UI 242 may also display severance documents for the user to review. For employee users, the task completion UI 242 may include an e-signature mechanism that allows the user to sign the agreement and upload the signed documents to the task module 240. Users may also change one or more aspects of a severance event (e.g., the status of one or more impacted employees, the notification date, the termination date, the severance amount, and the like) by inputting event modifications 245 into the task completion UI 242. If an event modification 245 is entered, the task completion UI 242 may require a modification justification 246 explaining why the modification was necessary. Other tasks included in the assignments 234 may also be completed in the task completion UI. For example, pre-assessment tasks, population validation tasks, report generation tasks, audits, and the like may be included in the completed tasks 248 output from the task completion UI 242.

The status or an employee and or severance event may be automatically updated by the task module 240 in response to the event modification 245. For example, the status of an employee that is added to the severance event population may be updated to “New” and the status of the severance event including the new employee may be changed from “Population Validated” to “New” in response to the new employee addition. The task module 240 may automatically generate new assignments 234 in response to the event modifications 245. To increase efficiency and limit the number of additional tasks that must be performed for a modified severance event, the new assignments 234 may be generated based on an analysis of the completed assignments and current status of the workflow for the severance event. For example, the task module 240 may determine that the severance event must go through the entire workflow if the event modification includes that addition of one or more employees. To ensure all of the completed work is reviewed again, the task module 240 may generate review assignments that require users to review and re-approve each step of the workflow. The review assignments may not affect any of the previously completed assignments and may mark all previously completed work as complete in order to avoid redundant tasks. Alternatively, if the event modifications 245 include edits to the severance event only and do not add employees to the population, the task module 240 may check to verify if legal and immigration has previously approved all employees in the population and may skip assignments for the pre-assessment review for all prior approved populations.

The task module 240 may also be coupled to the notification engine 232 because data collected by the review UI 242 may trigger creation of one or more notifications 236. For example, review confirmations 243 collected by the review UI 242 that approve a severance event may trigger generating a status update notification 236b indicating review of an event is completed. Additionally, modifications requests 245 may trigger creation of a modification action item and action item notification 236a that includes the modification justification 246. Assignments 234, notifications 236, and data collected by the review UI 242 may be stored in a severance database 270 to track the complete history of everything that occurs during a severance event. The full event level and employee history captured during execution of a severance event may be stored in the severance database 270 as severance event records and employee records. For example, the severance database 270 may store each assignment included in an event, a record all users working on the event, any modifications to employees and or severance events, any status changes may to an employee and or event as a result of a modification, any changes made to the severance amount calculations, all agreements generated during the severance event, any changes made to the agreements, all completed tasks, and all review confirmations included in a severance event and or employee record. One or more pieces of data from the severance event records and or the employee records may then be extracted from the severance database 270 and complied in a litigation report that lowers an organization's risk of litigation and liability.

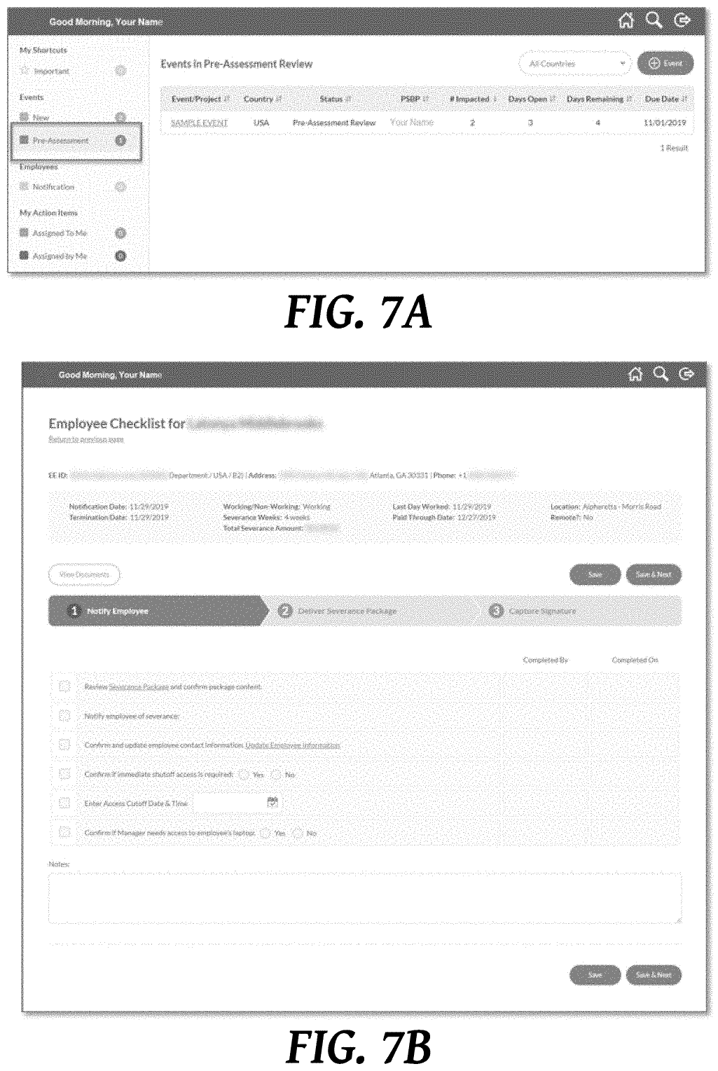

FIGS. 7A-B illustrate exemplary components of a review UI 242. FIG. 7A illustrates an event tracking UI that provides data about the overall progress of a severance event. The event tracking UI also includes a notification panel where users may review notifications that have been generated for one or more of their severance events. FIG. 7B illustrates an employee checklist UI that lists the steps required for an employee user to review and complete the severance event. As items in the checklist are completed, the boxes will be filled in by the review module 240. Once the checklist is completely filled, the review module 240 will generate a review confirmation confirming the employee has completed the severance event.

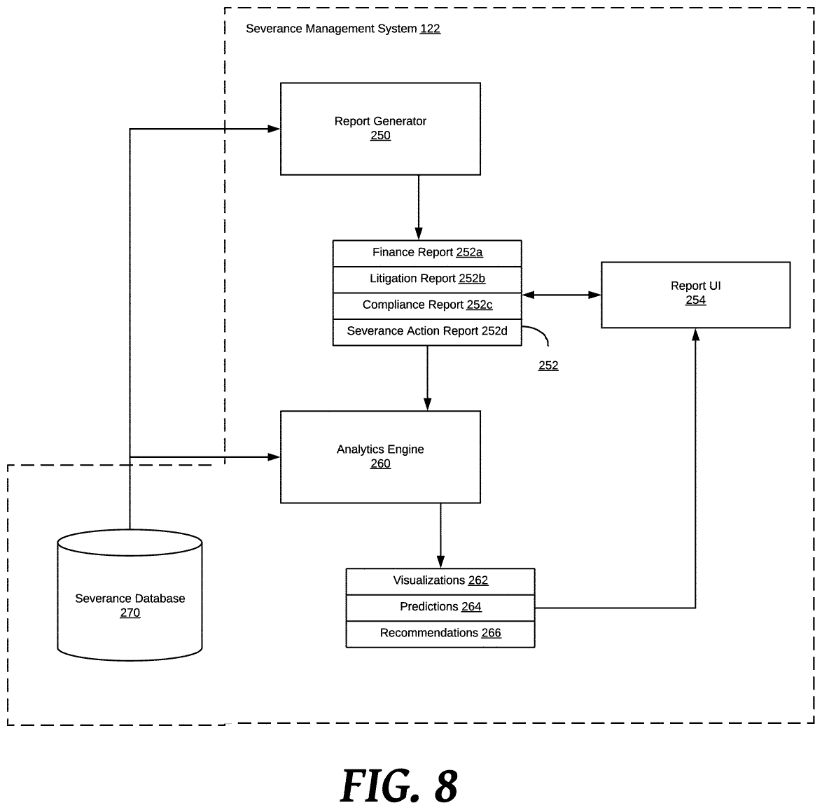

FIG. 8 illustrates more details of a report generator 250 and an analytics engine 260. The report generator 250 may process data from the severance database to generate one or more severance reports 252. The severance reports 252 document the RIF events for various uses including for example, financial projections and accounting purposes, internal audits, litigation events, and the like. Severance reports 252 may include a finance report 252a that displays financial data for the severance event including, for example, the amount of severance compensation paid, the total costs associated with providing other benefits, the cost of giving notice and completing all other steps of the severance process. The report generator 250 may also generate a litigation report 252b that includes severance event and employee level history of everything that occurred during the event (e.g., signed documents, completed assignments, severance amounts, event modifications, event justifications, employee justifications, modification justifications, employee files, and the like). The litigation report 252b may also include an employee and or RIF event level description of any changes made to the status (i.e., new, completed, modified) of a particular employee and or RIF event. The report generator 250 may also generate one or more compliance reports 252c (e.g., WARN and adverse impact reports) and a severance action report 252d documenting the amount of time required by each user of the severance management system 122 to complete each assignment included in the severance event. Other severance reports 252 generated by the report generator 250 may include employee date change reports that track any changes made to the notification date and or termination data for one or more employees included in a RIF event. Other severance reports may include a status summary report. The status summary report may provide employee and or RIF event level data on the status (e.g., pending pre-assessment review, completed pre-assessment review, pending population validation, completed population validation, pending legal review, completed legal review, pending notification, notified, delivered, signed, etc.) and or changes in status of employees and or RIF events on the severance management system 122. The status summary reports enable uses to track the progress of events and or employees assigned to them. Other severance reports 252 include employee signature reports that track completed and outstanding employee signature events and employee late notification reports that track employees having a “pending notification” status three days after the notification date for the employee. Severance reports 252 may be displayed in a report UI 254.

The severance management system 122 may integrate with one or more remote systems to distribute aspects of one or more severance reports 252 generated by the report generator 250 to external vendors. For example, the severance management system 122 may integrate with an outplacement system and/or vendor. The report generator 250 may distribute the outplacement benefit amount included in the finance report 252a to the outplacement vendor along with identification data for each employee included in the severance event. The employee identification data and outplacement amounts may be used by the outplacement vendor to automatically qualify and/or enroll impacted employees in outplacement benefits and notify the vendor of new users of outplacement services. Impacted employees may then access their outplacement benefits faster and without having to provide additional information.

The analytics engine 260 may process data from the severance database 270 and/or data included in one or more severance reports 252 to generate visualizations 262. Visualizations 262 may include charts, graphs, figures, and other graphics displaying data. The report UI 254 may integrate one or more visualizations 262 with the severance reports 252 to facilitate interpretation of the data included in the report. The analytics engine 260 may also include a data modeling and/or machine learning system that generates predictions 264 related to hiring, RIF, severance events and other aspects of employment. For example, the machine learning system may train a legal review pendency prediction model using a training dataset that includes the amount of time required to complete a legal review assignment for severance events having more than 50 impacted employees. Using the legal review pendency prediction model, the analytics engine 260 may generate a prediction 264 indicating how long legal review assignments for a severance event having 61 impacted employees will take to complete. Over time, as more severance events having more than 50 impacted employees are completed on the severance management system, the machine learning system may augment the training dataset with the amount of time required to complete a legal review assignment for the new severance events and retain the legal review pendency prediction model using the updated training dataset. Therefore, the predictions 264 generated by the analytics engine may improve over time as more data is collected by the severance management system.

The analytics engine 260 may also process data collected by the severance management system to generate one or more recommendations 266. The recommendations 266 may describe how to improve the performance of the severance management system 122, for example, by flagging issues in the review UI that commonly result in modification requests and/or automatically populating a considered group and or impacted group of employees with employees having demographics that will not have an adverse impact. The recommendations 266 may also describe how an organization can improve their severance process. For example, the recommendations 266 may describe how much time and money an organization would save by replacing their existing severance solution with the severance managing system after 10 severance events.

Other recommendations generated by the analytics engine 260 may include instructions for other business systems (e.g., payroll systems, outplacement systems, benefits systems, IT systems, and the like) that may be integrated with the severance management system 122. For example, the review UI may collect information about employee access to one or more business systems or other termination processes to complete an assignment (e.g., an HR assignment 234a, legal assignment 234b, and the like). Employee access cutoff dates, system permissions, laptop permissions, and other employee access restrictions collected during an assignment may be processed by the analytics engine 260 to generate an access modification recommendation. The recommendation 266 for access modification may be communicated to a particular service (e.g., building security system, business laptop, employee email account, business account for a web application, and the like) included in a business system to automatically terminate the employee's access to that business system as of the cutoff date specified in the assignment. Recommendations 266 may be saved in the severance database 270 and tracked over time.

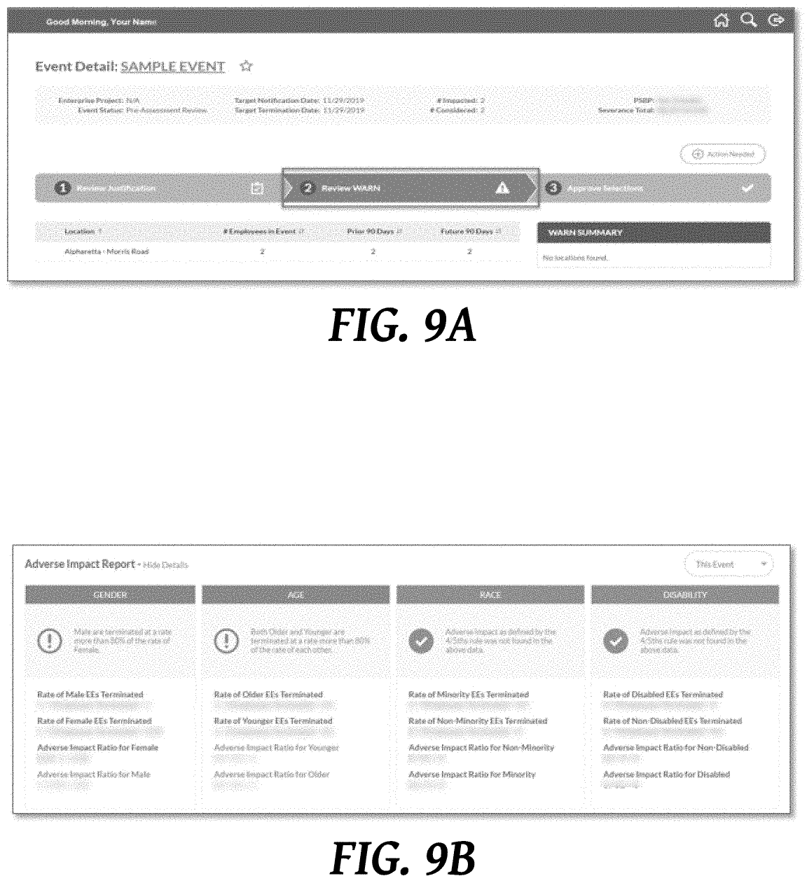

FIGS. 9A-9B illustrate exemplary severance reports 252 that may be generated by the report generator 250. FIG. 9A illustrates a WARN compliance report that documents the steps taken during the severance process to give impacted employees notice of the severance event. The WARN compliance report may be used to determine whether a severance event complies with federal and/or state regulations describing notice requirements. FIG. 9B illustrates an adverse impact report that documents the impact on the severance event on specific segments of the impacted group having a particular gender, age, race, or disability status. The adverse impact report flags potential compliance issues related to adverse impact to indicate there is a risk the severance event is not in compliance. The adverse impact report also indicates when the severance event has no potential compliance issues related to adverse impact.

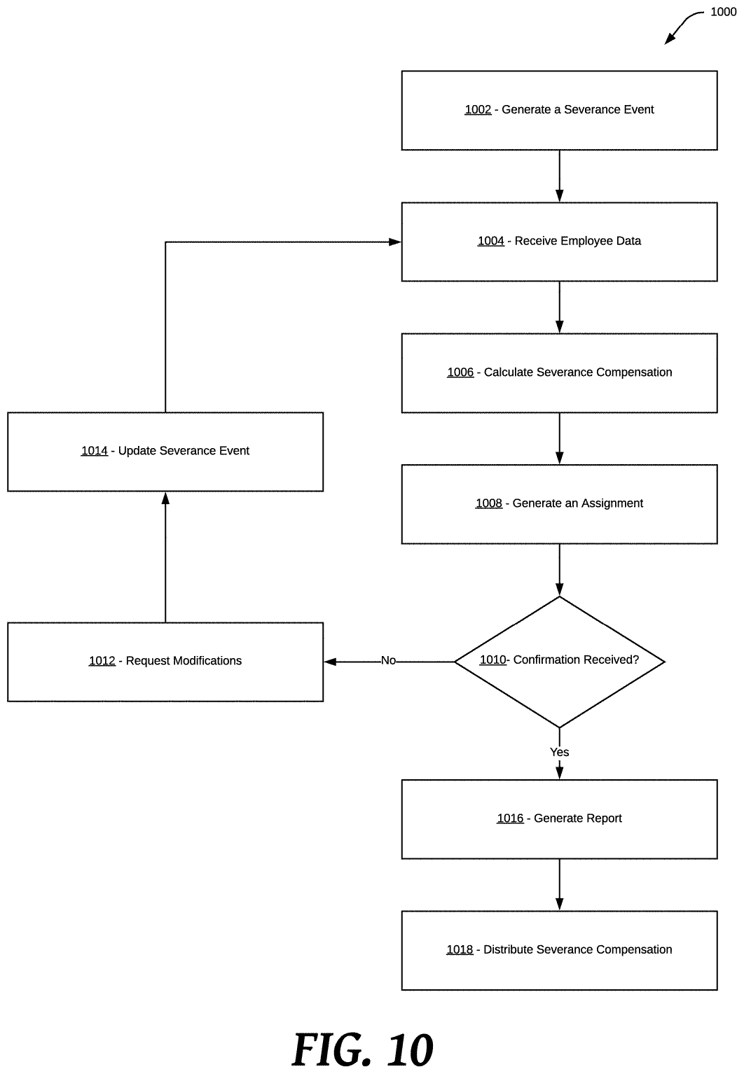

FIG. 10 is a flow chart illustrating an exemplary method for managing severance events 1000. At 1002, a user generates a severance event for a reduction in force event. The user may then model the severance event by, for example, using modeling UIs generated by the modeling module to search employee data for employees in an organization to select employees for a considered group of employees and an impacted group of employees. At 1004, one or more pieces of employee data is received for the employees in the impacted group of employees who will be impacted by the severance event. Employee data may be received from a network-based storage device having a collection of employee data stored thereon, for example, a remote sever having a database storing an organization's employee files and other employee data.

At 1006, severance compensation amounts are calculated by a severance calculator. Severance compensation may be calculated using a severance calculation algorithm including one or more configurable parameters, for example, role, service time, management level, grade, location, and salary. A document generator may also generator a severance agreement using the employee data. At 1008, an assignment generator generates one or more assignments for the severance event. The assignments may include action items that must be completed during the severance event. For example, the assignment generator may generate a legal review assignment including an action item to review one or more pieces of compliance data to confirm the severance event complies with the relevant regulations. Assignments may be displayed to users using a review UI generated by the review module.

The review UI may receive one or more user inputs including the actions required to complete the assignment. At 1010, the review UI may receive a confirmation indicating, for example, the legal review assignment has been completed and the user reviewing the severance event confirms the severance event complies with employment regulations. If a confirmation is received at 1010, the report generator may generate a report for the severance event at 1016. For example, the report generator may generate a litigation report including a comprehensive record of all actions that occurred and data generated during the severance event. If an organization is ever threated with litigation for actions taken during a severance event, the litigation report may be used to lower the organization's risk of litigation by documenting the steps the organization took to comply with employment regulations. The report generator may also generate a financial report conveying the costs of the severance event, a severance action report describing how the quickly each action item in the severance event was completed, a compliance report indicating whether or not the organization complies with a particular statute, and the like. Once the confirmation is received, the severance management system may also distribute and/or authorize distribution of severance compensation to an employee at 1018 via check, wire transfer, direct deposit, or any other payment mechanism. The severance management system may also be integrated with a payroll system and provide instructions to the payroll system to distribute severance compensation.

If the review UI does not receive a confirmation at 1010, the user may request a modification to the severance event at 1012. For example, if during the legal review assignment, a user does not believe the severance event complies with one or more regulations, the user may indicate the aspect of the severance event that needs to be modified to achieve compliance. The user may also enter a justification explaining why the modification must be made into the review UI. Once the modification is requested at 1012, the severance event may be updated at 1014. To update the severance event, the assignment generator may create a modification assignment and distribute the modification assignment to, for example, an human resources professional. The human resources professional may the update the severance event at 1014 to make the modification requested. Updating the severance event may require, for example, receiving new employee data at 1004, recalculating severance compensation at 1006, and generating an updated review assignment at 1008. The updated review assignment may include, for example, updated compliance data generated using the updated employee data. The updated review assignment may then be completed once the review UI receives a confirmation.

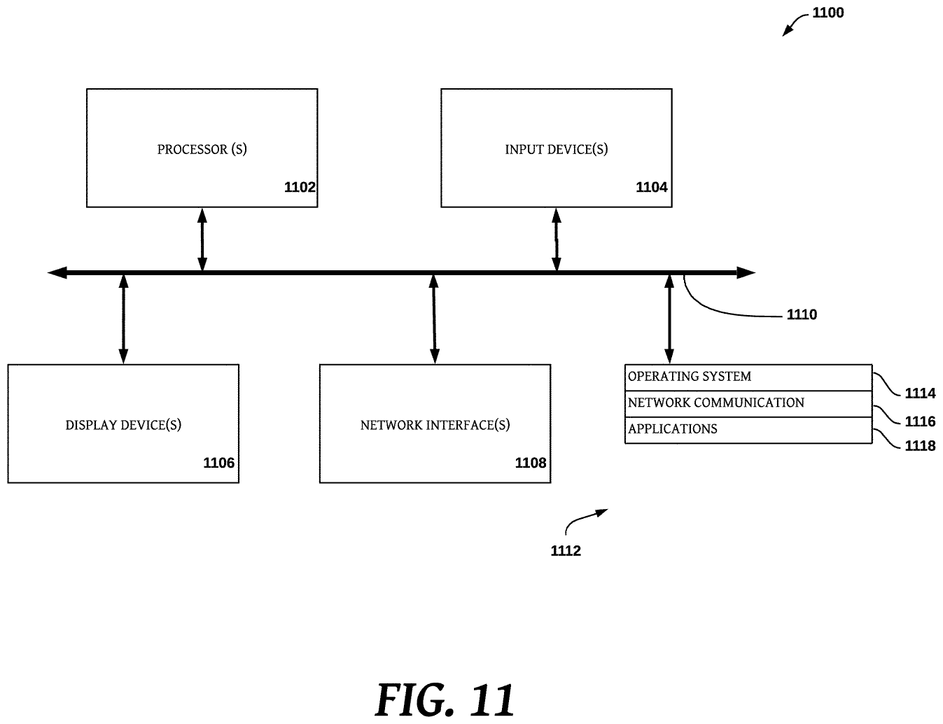

FIG. 11 shows a computing device 1100 according to an embodiment of the present disclosure. For example, the computing device 1100 may function as client device 150 which may implement a severance management system that tracks and manages severance events. The severance management system may provide a plurality of UIs 152 and send and receive data as required to complete severance events 154. The computing device 1100 may be implemented on any electronic device that runs software applications derived from compiled instructions, including without limitation personal computers, servers, smart phones, media players, electronic tablets, treatment planning systems, email devices, etc. In some implementations, the computing device 1100 may include one or more processors 1102, one or more input devices 1104, one or more display devices 1106, one or more network interfaces 1108, and one or more computer-readable mediums 1112. Each of these components may be coupled by bus 1110, and in some embodiments, these components may be distributed among multiple physical locations and coupled by a network.

Display device 1106 may be any known display technology, including but not limited to display devices using Liquid Crystal Display (LCD) or Light Emitting Diode (LED) technology. Processor(s) 1102 may use any known processor technology, including but not limited to graphics processors and multi-core processors. Input device 1104 may be any known input device technology, including but not limited to a keyboard (including a virtual keyboard), mouse, track ball, camera, and touch-sensitive pad or display. Bus 1110 may be any known internal or external bus technology, including but not limited to ISA, EISA, PCI, PCI Express, NuBus, USB, Serial ATA or FireWire. Computer-readable medium 1112 may be any medium that participates in providing instructions to processor(s) 1102 for execution, including without limitation, non-volatile storage media (e.g., optical disks, magnetic disks, flash drives, etc.), or volatile media (e.g., SDRAM, ROM, etc.).

Computer-readable medium 1112 may include various instructions 1114 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 1104; sending output to display device 1106; keeping track of files and directories on computer-readable medium 1112; controlling peripheral devices (e.g., disk drives, printers, etc.) which can be controlled directly or through an I/O controller; and managing traffic on bus 1110. Network communications instructions 1116 may establish and maintain network connections (e.g., software for implementing communication protocols, such as TCP/IP, HTTP, Ethernet, telephony, etc.).

Application(s) 1118 may be an application that uses or implements the processes described herein and/or other processes. For example, a severance management application that implements a severance management system. The processes may also be implemented in an operating system 1114. For example, an application 1118 and/or operating system 1114 may present UIs 152 which may include severance events 154 as described herein.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method for managing severance events comprising:
generating a severance event for a reduction in force event;
receiving one or more pieces of employee data for an employee impacted by the reduction in force event from a network-based storage device having a collection of employee data stored thereon;
calculating an amount of severance compensation the employee will receive during the severance event;
generating an assignment including a review action item for reviewing a piece of compliance data for the severance event, wherein the piece of compliance data determines if the severance event complies with an employment regulation;
receiving a confirmation that the assignment has been completed; and
upon receiving the confirmation, generating a litigation report for the severance event including the one or more pieces of employee data, the amount of severance compensation, the piece of compliance data, and the confirmation.

2. The method of claim 1, further comprising generating a severance agreement using the one or more pieces of employee data.

3. The method of claim 1, wherein the piece of compliance data includes a Worker Adjustment and Retraining Notification Act of 1988 (WARN) report.

4. The method of claim 1, wherein the piece of compliance data includes an adverse impact report.

5. The method of claim 1, further comprising:
storing the severance event in a standard formant on a network-based storage device having a collection of severance events stored thereon; and
providing remote access to the severance event to a plurality of users over a network so any one of the users can update at least one piece of data included in the severance event in real time through a user interface.

6. The method of claim 1, further comprising:
generating a second review action item included in the assignment, wherein the second review action item comprises reviewing a second piece of compliance data for the severance event;
receiving a request to modify the severance event based on the second piece of compliance data;
modifying the one or more pieces of employee data based on the request;
updating the second piece of compliance data to incorporate the modified one or more pieces of employee data;
generating an updated assignment including the updated second piece of compliance data; and
receiving a second confirmation that the updated assignment has been completed.

7. The method of claim 1, further comprising distributing the amount of severance compensation to the employee.

8. The method of claim 1, further comprising modeling a severance event by including the employee in an impacted group of employees based on at least one criterion.

9. The method of claim 8, wherein the at least one criterion includes at least one of a role, a manager, and a location.

10. The method of claim 1, wherein the amount of severance compensation is calculated based on a severance calculation algorithm.

11. The method of claim 10, wherein the severance calculation algorithm includes at least one configurable parameter, the at least one configurable parameter including at least one of a role, a service time, a management level, a grade, a location, and a salary.

12. The method of claim 1, further comprising generating at least one of a financial report, a severance action report, and a compliance report for the severance event.

13. The method of claim 12, further comprising:
analyzing at least one piece of data included in at least one of the litigation report, the financial report, the severance action report, and the compliance report to generate a prediction for a new severance event.

14. A system for managing severance events comprising:
a memory; and
a processor in communication with the memory and configured to:
generate a severance event for a reduction in force event;
receive one or more pieces of employee data for an employee impacted by the reduction in force event from a network-based storage device having a collection of employee data stored thereon;
calculate an amount of severance compensation the employee will receive during the severance event;
generate an assignment including a review action item for reviewing a piece of compliance data for the severance event, wherein the piece of compliance data determines if the severance event complies with an employment regulation;
receive a confirmation that the assignment has been completed; and
generate a litigation report for the severance event including the one or more pieces of employee data, the amount of severance compensation, the piece of compliance data, and the confirmation.

15. The system of claim 14, wherein the processor is further configured to generate a severance agreement using the one or more pieces of employee data.

16. The system of claim 14, wherein the piece of compliance data includes a Worker Adjustment and Retraining Notification Act of 1988 (WARN) report.

17. The system of claim 14, wherein the piece of compliance data includes an adverse impact report.

18. The system of claim 14, wherein the processor is further configured to:
store the severance event in a standard formant on a network-based storage device having a collection of severance events stored thereon; and
provide remote access to the severance event to a plurality of users over a network so any one of the users can update at least one piece of data included in the severance event in real time through a user interface.

19. The system of claim 14, wherein the processor is further configured to:
generate a second review action item included in the assignment, wherein the second review action item comprises reviewing a second piece of compliance data for the severance event;
receive a request to modify the severance event based on the second piece of compliance data;
modify the one or more pieces of employee data based on the request;
update the second piece of compliance data to incorporate the modified one or more pieces of employee data;
generate an updated assignment including the updated second piece of compliance data; and
receive a second confirmation that the updated assignment has been completed.

20. A client device comprising:
a display;
an input device; and
a processor in communication with the display and the input device and configured to:
generate a severance event for a reduction in force event;
receive one or more pieces of employee data for an employee impacted by the reduction in force event from a network-based storage device having a collection of employee data stored thereon;
calculate an amount of severance compensation the employee will receive during the severance event;
generate an assignment including a review action item for reviewing a piece of compliance data for the severance event, wherein the piece of compliance data determines if the severance event complies with an employment regulation;
receive a confirmation that the assignment has been completed; and
generate a litigation report for the severance event including the one or more pieces of employee data, the amount of severance compensation, the piece of compliance data, and the confirmation.
